(19) United States
(12) Patent Application Publication
(10) Pub. No.: US 2011/0303011 A1
(43) Pub. Date: Dec. 15, 2011

(54) SENSOR APPARATUS, SYSTEM AND METHOD PROVIDING COUPLING CHARACTERIZATION

(76) Inventors: Kai-Mei Camilla Fu, Palo Alto, CA (US); John Paul Strachan, Millbrae, CA (US); Peter G. Hartwell, Sunnyvale, CA (US)

(21) Appl. No.: 12/816,351

(22) Filed: Jun. 15, 2010

(51) Int. Cl. G01N 29/00

(52) U.S. Cl. 73/579

(57) ABSTRACT

A sensor apparatus, a sensor system and a method employ coupling characterization of a sensor housing to a local environment. The apparatus includes a vibration sensor and a vibration actuator attached to and enclosed by the sensor housing in a spaced apart relationship. The vibration actuator is configured to vibrate the sensor housing with a vibration signal to excite a coupling between the sensor housing and the local environment. A response of the sensor housing to the vibration signal is indicative of a coupling characteristic of the coupling. The system further includes a coupling structure. The method includes coupling the sensor housing to the local environment, vibrating the sensor housing with the vibration actuator and detecting the response that is indicative of the coupling characteristic.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Vibration sensors of various kinds including, but not limited to, accelerometers of various designs and configurations, velocity sensors, and geophones as well as other related acoustic transducers, are used in a wide variety of applications ranging from exploration to intrusion detection and perimeter defense. For example, an array of seismic sensors (e.g., geophones or accelerometers) that sense vibrations in the soil and subsurface layers of the earth may be deployed over a field in support of subsurface exploration activities. Similar seismic sensor arrays are routinely used to monitor naturally occurring seismic waves due to one or more of volcanic activity, tectonic movements (e.g., earthquakes), and other natural processes. In another example, the motion of bridges and other structures, either due to normal operation of the structure or induced on or within the structure by outside forces, may be monitored and even controlled using inputs from an array of vibration sensors. Likewise, vibration sensors deployed within a defensive perimeter or along a border may facilitate the detection of intruders as well as monitoring other activities associated with the perimeter or border, for example.

Often the numbers of vibration sensors that are used in a given application may become large or even very large (e.g., >>100-1000 vibration sensors per array). In addition, a speed at which vibration sensors are or may be deployed is often an important factor in certain applications (e.g., in battle field defense or large scale exploration applications). In many of these cases, ensuring a sufficient quality of a coupling between the vibration sensor and its environment (i.e., the source of vibration) and in some cases, characterizing the coupling, are important considerations. For example, quality and characterization of the coupling between the vibration sensor and the environment may be of critical importance for ensuring that measurements performed by the vibration sensor achieve a desired accuracy level. In another example, minimum level of coupling may necessary just for the vibration sensor to be useable.

Unfortunately, it is often difficult to one or both of guarantee and maintain a high quality coupling between a given vibration sensor and its environment during deployment. This may be especially true when either deployment speed is important or when a very large number of vibration sensors are being deployed.

### BRIEF DESCRIPTION OF THE DRAWINGS

The various features of embodiments of the present invention may be more readily understood with reference to the following detailed description taken in conjunction with the accompanying drawings, where like reference numerals designate like structural elements, and in which:

FIG. 1A illustrates a cross sectional view of a sensor apparatus, according to an embodiment of the present invention.

FIG. 1B illustrates a cross sectional view of the sensor apparatus, according to another embodiment of the present invention.

FIG. 2 illustrates a plot of a plurality of example responses of a sensor housing to a vibration signal, according to an embodiment of the present invention.

FIG. 3 illustrates a block diagram of a sensor system, according to an embodiment of the present invention.

FIG. 4 illustrates a flow chart of a method of coupling characterization of a vibration sensor, according to an embodiment of the present invention.

Certain embodiments of the present invention have other features that are one of in addition to and in lieu of the features illustrated in the above-referenced figures. These and other features of the invention are detailed below with reference to the preceding drawings.

### DETAILED DESCRIPTION

Embodiments of the present invention facilitate placing or deploying and generally using a vibration sensor in an environment. In particular, according to various embodiments, a connection or coupling between the vibration sensor and a local environment may be characterized in situ following deployment in a local environment. The coupling characterization provides information about the coupling that may be used to assess and even to mitigate an impact of the coupling on a performance of the vibration sensor, according to various embodiments. Further, deployment of the vibration sensor may be facilitated in that there may be a reduced need for ensuring high quality coupling at each and every vibration sensor that is deployed. Embodiments of the present invention are applicable to a wide variety of applications that employ vibration sensors including, but not limited to, seismic exploration, seismic monitoring, and structural monitoring.

For example, the coupling between sensor embodiments of the present invention and the local environment may interfere with and potentially degrade measurements of vibrations in the environment. In some instances, the measurements may be degraded to a point at which the vibration sensor is rendered substantially inoperative. Information provided by sensor embodiments of the present invention regarding the coupling characteristic of individual vibration sensors within an array of vibration sensors may be used to assist deployment by identifying specific vibration sensors that are adversely impacted by the coupling, for example. Vibration sensors identified as being adversely impacted by the coupling may be deemed unusable and removed from the array, for example. In some embodiments, the coupling characteristic provides information that effectively accounts for or characterizes the coupling. This characterizing information may be used for compensating measurements produced by the vibration sensor, according to some embodiments.

According to various embodiments, a vibration actuator and a vibration sensor are packaged together in or on a common housing. The vibration actuator is configured to vibrate the housing. The vibration excites a coupling between the housing and the local environment. The coupling is characterized by a coupling characteristic. In turn, the excited coupling influences the vibration of the housing. For example, the coupling may one or both of influence a magnitude and a frequency of the housing vibration. The coupling-influenced housing vibration is referred to herein as a ‘response’ to the coupling. In particular, as used herein, the response is defined as being indicative of the coupling characteristic of the coupling. Measuring or otherwise sensing the response facilitates determining and characterizing the coupling in terms of the coupling characteristic. In some embodiments, the response is measured with the vibration sensor itself while in other embodiments, another vibration sensor may be employed to measure the response. The determined coupling characteristic of the coupling is employed to mitigate an effect of the coupling on measurements produced by the vibration sensor in its deployed environment, according to various embodiments.

For simplicity herein, no distinction is made between direct and indirect attachment, unless explicitly so stated. In particular, no distinction is made between an element being attached directly to a housing and the element attached to the housing through an intervening structure or layer (e.g., a mounting plate or an adhesive film layer). Further, as used herein, the article ‘a’ is intended to have its ordinary meaning in the patent arts, namely ‘one or more’. For example, ‘a node’ generally means one or more nodes and as such, ‘the node’ means ‘the node(s)’ herein. Also, any reference herein to ‘top’, ‘bottom’, ‘upper’, ‘lower’, ‘up’, ‘down’, ‘left’ or ‘right’ is not intended to be a limitation herein. Herein, the term ‘about’ when applied to a value generally means plus or minus 10% unless otherwise expressly specified. Moreover, examples herein are intended to be illustrative only and are presented for discussion purposes and not by way of limitation.

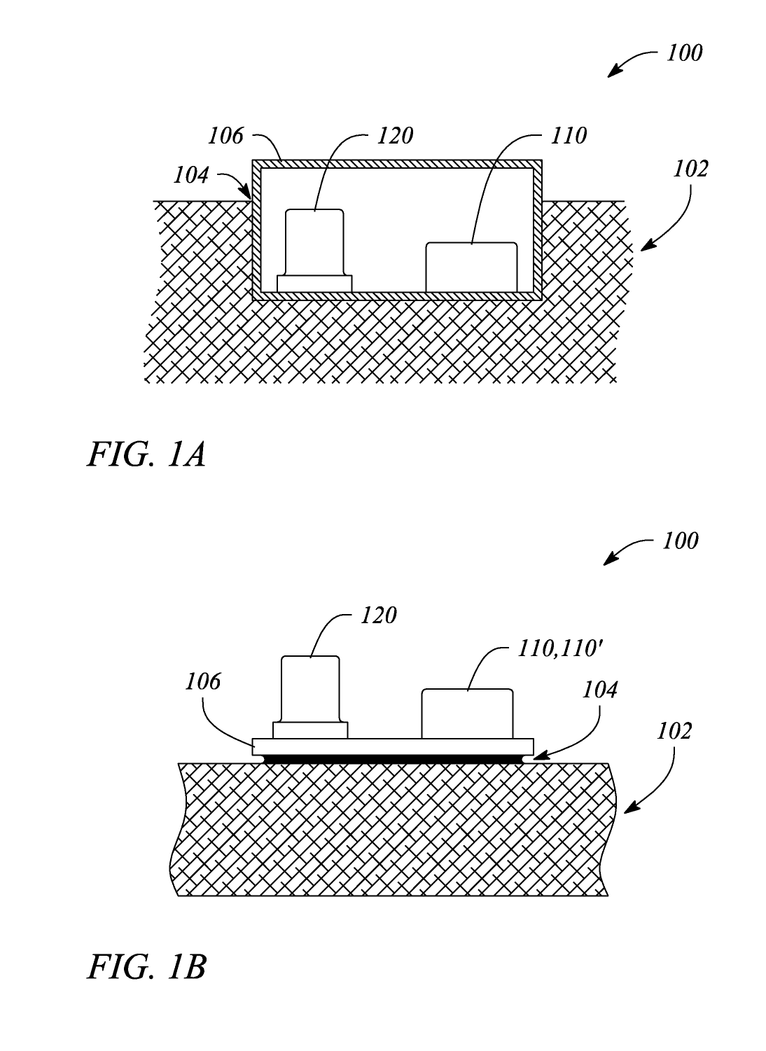

FIG. 1A illustrates a cross sectional view of a sensor apparatus 100, according to an embodiment of the present invention. In particular, as illustrated in FIG. 1A, the sensor apparatus 100 is partially embedded in a local environment 102.

FIG. 1B illustrates a side view of the sensor apparatus 100, according to another embodiment of the present invention. Specifically, as illustrated in FIG. 1B, the sensor apparatus 100 is mounted to a surface portion of the local environment 102. As illustrated in FIGS. 1A and 1B, the sensor apparatus 100 is configured to receive and detect (i.e., sense) vibration in the local environment 102. In general, the local environment 102 may be substantially anything that supports or is capable of supporting a vibration that the sensor apparatus 100 may be configured to receive and detect.

For example, the local environment may be the earth (e.g., soil). Where the local environment 102 is the earth, the sensor apparatus 102 may receive and detect seismic vibrations, for example. The seismic vibrations for example may be due to any of a number of sources including, but not limited to, naturally occurring seismic waves, seismic vibrations induced by a man-made source used for subsurface exploration and mapping (e.g., an explosive charge), or seismic vibrations associated with movement of people or vehicles on the surface of the earth near the sensor apparatus 100.

In another example, the local environment 102 may comprise a structure such as, but not limited to, a building, a bridge, an airframe, a hull of a ship, and an automobile body or frame. Where the local environment 102 comprises a structure, the received and detected vibrations may be vibrations of or within the structure. Structural vibrations may be due to activities associated with the functioning of the structure. For an example structure comprising a bridge, the vibrations received and detected by the sensor apparatus 100 may be due to vehicles passing across a bridge. In another example, the vibrations received and detected by the sensor apparatus 100 may be associated with differential flexure of an airframe experiencing turbulence. In yet another example, the vibrations may be produced in the hull of a ship traveling through waves on the ocean surface. Similarly, vibrations induced in a structure (e.g., an airframe, building, etc.) may be associated with equipment operating one or both of on an exterior of and within an interior of the structure (e.g., a motor within a boat or cooling equipment mounted on the roof of a building).

The sensor apparatus 100 is coupled to the local environment 102 by a coupling 104. In some embodiments, the coupling 104 comprises a portion of the local environment 102. In some embodiments, the coupling 104 may comprise a material of the local environment 102 that is in direct contact with the sensor apparatus 100. For example, the coupling 104 may comprise material (e.g., sand, mud, gravel) of the local environment 102 (e.g., soil) in which the sensor apparatus 100 is embedded, as illustrated in FIG. 1A. In another example, such as when the sensor apparatus 100 is simply resting on a surface of the local environment 102, the portion of the local environment comprises material of the local environment surface. In these examples, the coupling 104 may further comprise conditions associated with the resting sensor apparatus 100 (e.g., an ability to bounce on the surface under the influence of gravity).

In other embodiments, the coupling 104 may comprise a mounting structure used to affix or mount the sensor apparatus 100 in the local environment 102. For example, the mounting structure acting as the coupling 104 may comprise a mounting structure such as, but not limited to, a bracket bolted or otherwise connected to the local environment 102 (e.g., a concrete mounting pad) that is used to secure the sensor apparatus 100. In yet another embodiment, the coupling 104 may comprise a mounting structure comprising a semi-resilient or even flexible layer (e.g., bushing, washer, flashing, mounting adhesive, etc.) located between the sensor apparatus 100 and the local environment 102, for example. In another example, the coupling 104 may comprise a suspension of a vehicle in which the sensor apparatus 100 is mounted. In yet other embodiments, the coupling 104 may comprise a combination of a mounting structure and a portion of the local environment 102 (e.g., a cushioned mounting platform resting on loose gravel or sand). FIG. 1B reflects some of these various embodiments.

Regardless of the specific embodiment, the coupling 104 may interfere with or otherwise distort a vibration signal received from the local environment 102 for detection by the sensor apparatus 100. In particular, the coupling 104 may provides a less than ideal connection for communicating the vibration signal from the local environment 102 into the sensor apparatus 100 for reception and detection. The influence of the coupling 104 on a performance of the sensor apparatus 100 may be described by a coupling characteristic of the coupling 104. For example, the coupling 104 may be represented as comprising a spring (i.e., an energy storage structure) and a vibration damper (i.e., an energy loss or dissipation structure), according to some embodiments.

The coupling characteristic of the example spring/damper coupling 104 comprises a spring constant k of the spring and a damping constant of the damper.

According to various embodiments, the coupling 104 is between the local environment 102 and a housing 106 of the sensor apparatus 100. The housing 106 is referred to herein as a ‘sensor housing’ 106 since the housing substantially houses or otherwise provides a mechanical interface between the sensor apparatus 100 and the local environment 102. In particular, according to some embodiments, the sensor housing 106 may enclose components and other constituent elements of the sensor apparatus 100. For example, the sensor housing 106 that encloses the sensor apparatus 100 components and other constituent elements may comprise an integrated circuit package that holds integrated circuits (ICs) used to implement the sensor apparatus 100. The sensor housing 106 may comprise a box or similar structure (e.g., as illustrated in FIG. 1A) used to hold circuit boards upon which the sensor apparatus 100 is implemented, in another example. In other embodiments, the sensor housing 106 either does not enclose the components and constituent elements of the sensor apparatus 100 or does not fully enclose the components and constituent elements. In the latter embodiment, the sensor housing 106 provides only semi enclosure of the sensor apparatus 100 components and constituent elements. For example, a semi-enclosing sensor housing 106 may comprise a mounting plate or board upon which the components of the sensor apparatus 100 are affixed (e.g., as illustrated in FIG. 1B). In another example, the semi-enclosing sensor housing 106 may comprise a mounting plate and one or more walls but no lid. The semi-enclosing sensor housing 106 may comprise a tube that has one or both ends open, in yet another example.

As illustrated in FIGS. 1A and 1B, the sensor apparatus 100 comprises a vibration sensor 110. The vibration sensor 110 is attached to the sensor housing 106. The vibration sensor 110 may be attached using substantially any means of attaching including, but not limited to, one or more of an adhesive (e.g., glue, epoxy, tape), solder, a weld, and various mechanical fasteners (e.g., screws, bolts, clamps, etc.), for example. In some embodiments, the means for attachment may further comprise an intervening layer or structure between the vibration sensor 110 and the sensor housing 106 (e.g., an IC socket or package). In some embodiments, the sensor housing 106 encloses the vibration sensor 110 (e.g., as illustrated in FIG. 1A).

In various embodiments, the vibration sensor 110 may be substantially any transducer that may be used to sense a vibration. Examples of transducers that sense a vibration include, but are not limited to, an accelerometer (e.g., a piezoelectric accelerometer, a micro electro-mechanical system (MEMS) accelerometer), a velocity sensor, a geophone and a seismometer. Other example transducers may sense the vibration indirectly including, but are not limited to, various sensors that measure strain or pressure waves associated with the vibration. Examples of these sorts of sensors include strain-based piezoelectric sensors, microphone-type sensors, capacitor-based microphone-type sensor and various sensors based on piezo-resistivity.

The sensor apparatus 100 further comprises a vibration actuator 120. The vibration actuator 120 is attached to the sensor housing 106. In particular, the vibration actuator 120 is attached to the sensor housing 106 spaced apart from the attached vibration sensor 110. The vibration actuator 120 may be attached using substantially an means of attaching including, but not limited to, one or more of an adhesive (e.g., glue, epoxy, tape), solder, a weld, and various mechanical fasteners (e.g., screws, bolts, clamps, etc.), for example. In some embodiments, the means for attachment may further comprise an intervening layer or structure between the vibration actuator 120 and the sensor housing 106 (e.g., an IC socket or package). In some embodiments, the vibration actuator 120 attached to the sensor housing 106 is further enclosed by the sensor housing 106 along with the vibration sensor 110 (e.g., as illustrated in FIG. 1A).

In various embodiments, the vibration actuator 120 is configured to vibrate the sensor housing 106 with a vibration signal. In particular, the vibration signal produced by the vibration actuator 120 is communicated to the sensor housing 106 through the attachment between the vibration actuator 120 and the sensor housing 106, according to some embodiments. The actuator vibration signal excites the coupling 104 between the sensor housing 106 and the local environment 102. The vibration actuator 120 may be substantially any transducer that may be used to vibrate the sensor housing 106 with the actuator vibration signal. Examples of transducers that may be used to produce a vibration include, but are not limited to, a piezoelectric vibrator, a MEMS vibrator, an audio speaker (i.e., a magnetized mass moved by a variable magnetic field), an electrically charged mass moved by a variable electric field, and an electric motor with an unbalanced rotating mass.

According to various embodiments, a response of the sensor housing 106 to the actuator vibration signal is indicative of a coupling characteristic of the coupling 104. In particular, the coupling 104 may act on or influence the sensor housing 106. The influence of the coupling 104 changes the response of the sensor housing 106 to the actuator vibration signal relative to a response obtained under a calibration condition (e.g., in the laboratory). An amount and type of change in the response is determined by the coupling characteristic of the coupling 104. In some embodiments, the amount and type of the change may actually facilitate determining the coupling characteristic of the coupling 104. In other embodiments, the amount and type of the change may simply provide information regarding usability of the deployed or coupled sensor apparatus 100.

In some embodiments, the vibration sensor 110 itself receives and detects the response of the sensor housing 106 to the actuator vibration signal. In particular, the vibration sensor 110 may directly receive and detect the response of the sensor housing 106 to the actuator vibration signal as influenced by the coupling 104. In other embodiments, another vibration sensor 110′ is employed to determine the response of the sensor housing 106 to the vibration signal produced by the vibration actuator 120. In some embodiments, the other vibration sensor 110′ is packaged together with the vibration sensor 110 in a common housing (e.g., as illustrated in FIG. 1B).

In some embodiments, the vibration signal of the vibration actuator 120 is configured to excite a resonance of the sensor housing 106. The response indicative of the coupling characteristic (also referred to herein as the ‘coupling characteristic indicative response’) may comprise a change in one or both of a resonance frequency and a resonance magnitude of the sensor housing 106 relative to a calibration condition of the sensor apparatus 100. For example, the resonance magnitude may be reduced due to damping associated with the coupling characteristic of the coupling 104. In another example, a resonance frequency may be moved up or down in frequency relative to a frequency of the resonance under the calibration condition. In yet another example, both the resonance frequency and the resonance magnitude may change from that of the calibration condition as a result of the influence of the coupling 104. Herein, the ‘calibration condition’ is defined as any predetermined condition of the coupling between the sensor housing 106 and a local environment (e.g., a laboratory setting) against which a change in the resonance (or other indicative response) may be determined.

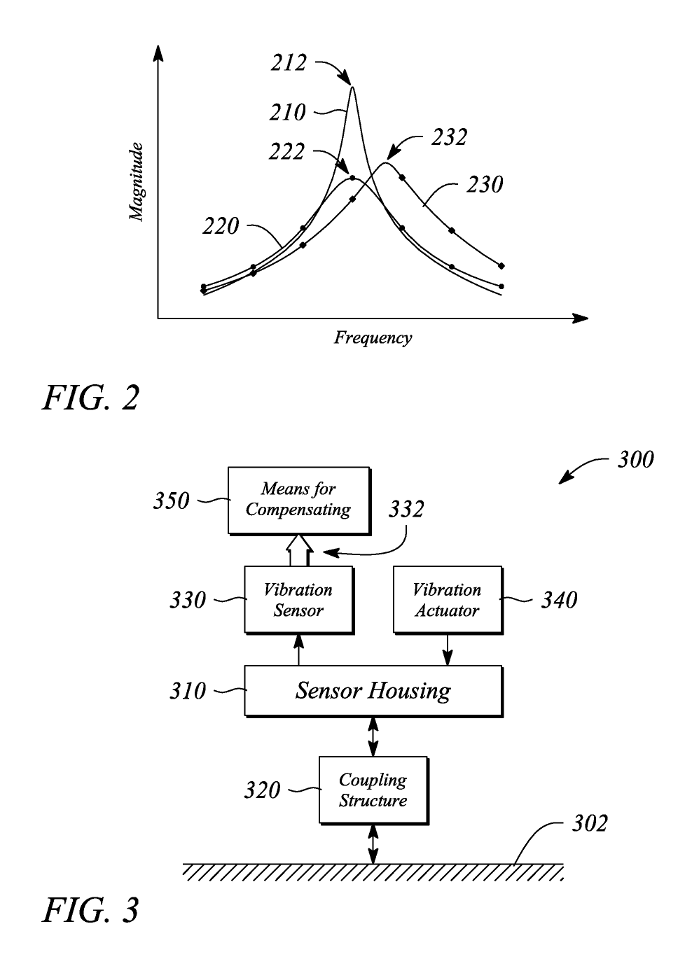

FIG. 2 illustrates a plot of a plurality of example responses of a sensor housing to a vibration signal, according to an embodiment of the present invention. In particular, FIG. 2 illustrates several curves depicting the plurality of example responses in terms of a magnitude of an induced vibration of an example sensor housing as a function of frequency (i.e., a response spectrum). A resonance in the example response spectrum of the sensor housing may be identified or associated with a peak in each of the curves. The resonance and by association the peak in the response spectrum may be described or characterized by a quality factor or ‘Q’ of the resonance. A first curve 210 is indicative of a calibration condition of the sensor apparatus 100 (e.g., when the sensor apparatus 100 is bolted firmly to a laboratory bench providing a substantially ideal coupling 104). The response spectrum illustrated in the first curve 210 has strong or sharp resonance as indicated by a peak 212, for example. A sharp peak is characteristic of a high-Q resonant structure.

A second curve 220 illustrated in FIG. 2 depicts a response spectrum of the example sensor housing 106 of the sensor apparatus 100 in the presence of an example coupling 104 with a coupling characteristic that exhibits some damping (e.g., moderate damping). The resonance indicated by the peak 222 is still evident. However, a sharpness and height of the peak 222 is reduced compared to the calibration condition peak 212 in the first curve 210. As such, the coupling 104 has evidently decreased the Q of the resonance. A third curve 230 illustrated in FIG. 2 depicts a sensor housing response spectrum where the example coupling 104 has induced both a change in frequency of the resonance and a reduction in the Q of the resonance. In particular, a peak 232 in the third curve 230 is shifted higher in frequency while simultaneously the peak 232 is lower and considerably less sharp than under the calibration condition. Such a shift in frequency with a concomitant reduction in Q of the sensor housing resonance may occur when the coupling 104 exhibits a coupling characteristic that includes both a damping and a non-zero spring constant, for example.

In some embodiments, the vibration signal comprises substantially a single frequency. For example, the vibration signal may comprise a sine wave having a single frequency. The coupling characteristic indicative response may be a damped version of the vibration signal. A level of the damping may be compared to a threshold, for example.

In other embodiments, the vibration signal comprises a plurality of frequencies. For example, the vibration signal may comprise a frequency sweep or chirp that includes frequencies between a first frequency f₁ and a second frequency f₂. The frequency sweep may be linear with respect to time, for example. In another example, the vibration signal may comprise another relatively broadband source including, but not limited to, a noise source. In yet other embodiments, the vibration signal may comprise an impulse or a step function applied to the sensor housing 106. Impulses and step functions are known to be broadband.

In each of these embodiments in which the vibration signal includes multiple frequencies, the coupling characteristic indicative response may comprise a location and a magnitude of one or more spectral peaks. Changes in one or both of the location and the magnitude relative to those of spectral peaks in a calibration condition may be used to determine the coupling characteristic, for example.

In some embodiments (not illustrated in FIGS. 1A and 1B), the sensor apparatus 100 further comprises a means for compensating for the coupling characteristic. The means for compensating is configured to adjust an output of the sensor apparatus 100 according to the coupling characteristic indicative response. According to some embodiments, the means for compensating for the coupling characteristic comprises a threshold against which the coupling characteristic indicative response is compared. The comparison is configured to determine whether or not the output from the sensor apparatus is usable. In other embodiments, the means for compensating may be configured to apply a correction to measurements produced by the vibration sensor 110.

The correction may mitigate some of the error that may be introduced into the measurements by the coupling 104.

The means for compensating may be implemented within the sensor housing 106 of the sensor apparatus 100, according to some embodiments. For example, the sensor apparatus 100 may further comprise a microprocessor that executes a computer program, instructions of which implement compensation when executed. The instructions of the computer program, when executed, may adjust the output of the sensor apparatus 100 based on the coupling characteristic indicative response, for example. In another example, the means for compensating may be implemented as an applications specific integrated circuit (ASIC) or even using discrete logic devices on circuit boards of the sensor apparatus 100.

FIG. 3 illustrates a block diagram of a sensor system 300, according to an embodiment of the present invention. The sensor system 300 is configured to receive and measure vibrations in a local environment 302. In some embodiments, the local environment 302 is substantially similar to the local environment 102 described above with respect to the sensor apparatus 100.

The sensor system 300 comprises a sensor housing 310 and a coupling structure 320. The coupling structure 320 is configured to couple the sensor housing 310 to the local environment 302. In some embodiments, the sensor housing 310 is substantially similar to the sensor housing 106 described above with respect to the sensor apparatus 100. In some embodiments, the coupling structure 320 is substantially similar to the coupling 104 described above with respect to the sensor apparatus 100.

The sensor system 300 further comprises a vibration sensor 330. The vibration sensor 330 is attached to the sensor housing 310. The vibration sensor 330 is configured to provide measurements of a vibration in the local environment 302. The vibration measurements may be influenced by the coupling structure 320 through a performance of the coupling structure 320. The vibration measurements provided by the vibration sensor 330 may be communicated as an output of the sensor system 300 through an output channel 332, according to some embodiments.

The sensor system 300 further comprises a vibration actuator 340. The vibration actuator 340 is attached to the sensor housing 310 and spaced apart from the attached vibration sensor 330. The vibration actuator 340 is configured to vibrate the sensor housing 310 in the coupled 320 local environment using an actuator vibration signal. A response of the sensor housing 310 to the vibration provided by the vibration actuator 340 is indicative of a coupling characteristic of the coupling structure 320. In some embodiments, the vibration actuator 340 is substantially similar to the vibration actuator 120 described above with respect to the sensor apparatus 100.

In some embodiments, the sensor system 300 further comprises a means for compensating 350 for the coupling characteristic of coupling structure 320 in the vibration measurements provided by the vibration sensor 330. In some embodiments, the means for compensating 350 is implemented within or on the sensor housing 310. In these embodiments, the means for compensating 350 may be substantially similar to the means for compensating described above with respect to the sensor apparatus 100.

In other embodiments, the means for compensating 350 may be implemented remote to the sensor housing 310. For example, the means for compensating 350 may be implemented as a computer program, ASIC, or similar structure in a base station or unit (not illustrated) that receives data from the vibration sensor 330. The base station may aggregate data from a plurality of vibration sensors 330, for example. Raw data including the coupling characteristic indicative response may be transmitted from the vibration sensor 330 to the base station via the output channel 332 for further processing by the means for compensating 350, for example.

The further processing performed by the means for compensating 350 may comprise compensating for the coupling characteristic, for example. Specifically, the means for compensating 350 may adjust the measurements based on a comparison between the coupling characteristic indicated by the response and a model of the coupling available to the means for compensating 350. In another example, the means for compensating 350 comprises a predetermined threshold against which the coupling characteristic indicative response is compared. The comparison is configured to determine whether or not vibration measurements provided by the vibration sensor 330 are usable. If the vibration measurements are determined to be unusable (e.g., a resonance peak that is below the predetermined threshold), the means for compensating 350 may disable or otherwise ignore measurements from the vibration sensor 330.

Regardless of whether the means for compensating 350 is implemented local to or remote from the sensor housing 310, the means for compensating 350 may comprise a microprocessor that executes a computer program, instructions of which when executed implement compensation, as described above for example. In another example, the means for compensating 350 may be implemented as an applications specific integrated circuit (ASIC) or even using discrete logic devices on circuit boards.

In some embodiments, the sensor system 300 further comprises another vibration sensor (not illustrated). For example, the other vibration sensor may have a frequency response or a vibration sensitivity that is better suited for sensing the coupling characteristic indicative response than the vibration sensor 330. In particular, the other vibration sensor may comprise a frequency response configured to detect a response frequency (e.g., a resonance frequency) of the sensor housing 310.

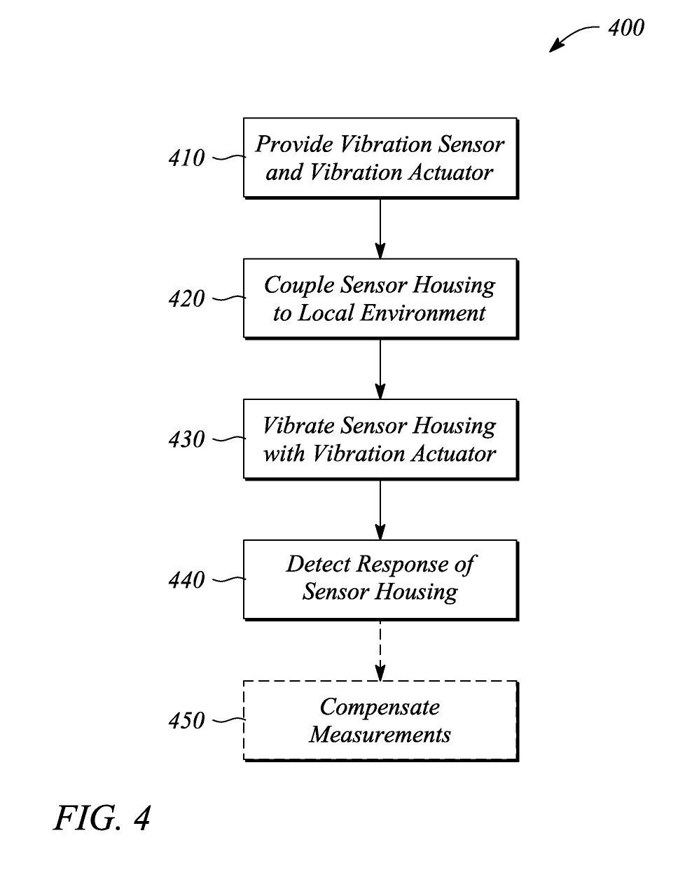

FIG. 4 illustrates a flow chart of a method 400 of coupling characterization of a vibration sensor, according to an embodiment of the present invention. The method 400 of coupling characterization comprises providing 410 the vibration sensor and a vibration actuator. The vibration sensor and the vibration actuator are provided 410 separately attached to a sensor housing. Further, the attached vibration sensor is provided 410 spaced apart from the attached vibration actuator on the sensor housing. In some embodiments, the provided 410 vibration sensor is substantially similar to the vibration sensor 110 described above with respect to the sensor apparatus 100. In some embodiments, the provided 410 vibration actuator is substantially similar to the vibration actuator 120 described above with respect to the sensor apparatus 100.

The method 400 of coupling characterization further comprises coupling 420 the sensor housing to a local environment. The coupling is characterized by a coupling characteristic that represents a quality of the coupling. In some embodiments, coupling 420 the sensor housing employs one or both of a coupling and a coupling structure, wherein the coupling is substantially similar to the coupling 104 described above with respect to the sensor apparatus 100, and wherein the coupling structure is substantially similar to the coupling structure 320 described above with respect to the sensor system 300. The local environment may be substantially similar to the local environment 102 described above with respect to the sensor apparatus 100.

The method 400 of coupling characterization further comprises vibrating 430 the sensor housing with a vibration signal produced by the vibration actuator. The vibration signal may be substantially similar to the actuator vibration signal described above with respect to the sensor apparatus 100 and the sensor system 300, for example. The method 400 of coupling characterization further comprises detecting 440 a response of the sensor housing to the actuator vibration signal. The detected 440 response is indicative of the coupling characteristic. The response indicative of the coupling characteristic may be substantially similar to the coupling characteristic-indicative response described above with respect to the sensor apparatus 100, for example.

In particular, according to some embodiments, vibrating 430 the sensor housing comprises applying one of an impulse and a frequency sweep to the sensor housing using the vibration actuator. In some of these embodiments, the coupling characteristic indicative response comprises a location and a magnitude of a spectral peak. According to some embodiments, vibrating 430 the sensor housing comprises vibrating the sensor housing into resonance. In some of these embodiments, the coupling characteristic indicative response is one or both of a resonance frequency and resonance magnitude that differs from a respective resonance frequency and resonance magnitude of the sensor housing under a calibration condition.

The method 400 of coupling characterization further comprises compensating 450 measurements produced by the vibration sensor for the coupling characteristic, according to some embodiments (e.g., as illustrated by a dashed line in FIG. 4). In some embodiments, compensating 450 measurements comprises determining from the indicated coupling characteristic whether or not to use the measurements produced by the vibration sensor. Determining may comprise comparing a feature or features of the coupling characteristic indicative response to a predetermined threshold and making a decision about using the measurements based on the comparison, according to some embodiments. For example, a spectral peak in the coupling characteristic indicative response may be located and compared to one or both of a magnitude threshold and a frequency threshold. If the comparison indicates the spectral peak exceeds the magnitude threshold, for example, the measurements may be deemed one or both of reliable and useable. In another example, a resonance magnitude in the coupling characteristic indicative response may be compared to a predetermined threshold. If the resonance magnitude is less than the predetermined threshold it may be inferred that the coupling exhibits excessive damping. Under this situation, the measurements may be discarded (i.e., not used) since the excessive damping would likely render the measurements of little value. The predetermined threshold may be determined in a calibration of the vibration sensor in a laboratory setting, for example.

In other embodiments, compensating 450 measurements may comprise attempting to remove an effect of the coupling from measurements produced by the vibration sensor. For example, the coupling characteristic indicative response may be employed to adjust parameters of a model of the coupling in a computer system. The model may represent a transfer function of the coupling, for example. Once the parameters are adjusted, the computer model may be used to mathematically remove effects of the coupling to mitigate how the coupling effects the measurements.

Thus, there have been described embodiments of a sensor apparatus and system as well as a method of coupling characterization that provide characterization of a sensor coupling to a local environment. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

What is claimed is:

1. A sensor apparatus comprising:
a vibration sensor attached to a sensor housing; and
a vibration actuator attached to the sensor housing, the vibration actuator being spaced apart from the vibration sensor, the vibration actuator being configured to vibrate the sensor housing with a vibration signal to excite a coupling between the sensor housing and a local environment,
wherein a response of the sensor housing to the vibration signal is indicative of a coupling characteristic of the coupling.

2. The sensor apparatus of claim 1, wherein the sensor housing is configured to enclose the vibration sensor and the vibration actuator.

3. The sensor apparatus of claim 1, wherein the vibration sensor comprises one of an accelerometer and a geophone.

4. The sensor apparatus of claim 1, further comprising another vibration sensor, the other vibration sensor being configured to receive and detect the coupling characteristic indicative response of the sensor housing to the vibration signal.

5. The sensor apparatus of claim 1, wherein the vibration signal of the vibration actuator is configured to excite a resonance of the sensor housing, the coupling characteristic indicative response comprising a change in one or both of a resonance frequency and a resonance magnitude relative to a calibration condition of the sensor apparatus.

6. The sensor apparatus of claim 1, wherein the vibration signal comprises a one of a frequency sweep and an impulse, and wherein the coupling characteristic indicative response comprises a location and a magnitude of a spectral peak.

7. The sensor apparatus of claim 1, further comprising means for compensating for the coupling characteristic, the means for compensating being configured to adjust an output of the sensor apparatus according to the coupling characteristic indicative response.

8. The sensor apparatus of claim 7, wherein the means for compensating for the coupling characteristic comprises a predetermined threshold against which the coupling characteristic indicative response is compared, the comparison being configured to determine whether or not the output from the sensor apparatus is usable.

9. A sensor system comprising:
a sensor housing;
a coupling structure configured to couple the sensor housing to a local environment;
a vibration sensor attached to the sensor housing, the vibration sensor being configured to provide a measurement of a vibration in the local environment; and
a vibration actuator attached to the sensor housing and spaced apart from the attached vibration sensor, the vibration actuator being configured to vibrate the sensor housing in the coupled local environment,
wherein a response of the sensor housing to the vibration provided by the vibration actuator is indicative of a coupling characteristic of the coupling structure.

10. The sensor system of claim 9, further comprising means for compensating for the coupling characteristic of the coupling structure in the vibration measurement provided by the vibration sensor.

11. The sensor system of claim 10, wherein the means for compensating comprises a predetermined threshold against which the coupling characteristic indicative response of the sensor housing is compared, the comparison being configured to determine whether or not the vibration measurement provided by the vibration sensor is usable.

12. The sensor system of claim 10, wherein the vibration signal of the vibration actuator is configured to excite a resonance of the sensor housing, the response indicative of the coupling characteristic being a change in the resonance relative to a calibration condition of the vibration sensor.

13. The sensor system of claim 12, further comprising another vibration sensor with a frequency response configured to detect a resonance frequency of the sensor housing.

14. A method of coupling characterization of a vibration sensor, the method comprising:
providing the vibration sensor and a vibration actuator separately attached to a sensor housing, the attached vibration sensor being spaced apart from the attached vibration actuator;
coupling the sensor housing to a local environment, the coupling being characterized by a coupling characteristic;
vibrating the sensor housing with a vibration signal produced by the vibration actuator; and
detecting a response of the sensor housing to the vibration signal, the response being indicative of the coupling characteristic.

15. The method of coupling characterization of claim 14, wherein the vibration sensor detects the response.

16. The method of coupling characterization of claim 14, wherein the vibration sensor and the vibration actuator are enclosed by the sensor housing.

17. The method of coupling characterization of claim 14, wherein vibrating the sensor housing comprises applying one of an impulse and a frequency sweep to the sensor housing using the vibration actuator, and wherein the coupling characteristic indicative response of the sensor housing comprises a location and a magnitude of a spectral peak.

18. The method of coupling characterization of claim 14, wherein vibrating the sensor housing comprises vibrating the sensor housing into resonance, the coupling characteristic indicative response of the sensor housing being one or both of a resonance frequency and a resonance magnitude that differs from a respective resonance frequency and resonance magnitude of the sensor housing under a calibration condition.

19. The method of coupling characterization of claim 14, further comprising compensating measurements produced by the vibration sensor for effects of the detected response of the sensor housing indicative of the coupling characteristic of the coupling.

20. The method of coupling characterization of claim 19, wherein compensating measurements comprises determining from the detected response whether or not to use the measurements produced by the vibration sensor.
